(19) United States
(12) Patent Application Publication
(10) Pub. No.: US 2011/0225382 A1
(43) Pub. Date: Sep. 15, 2011

(54) INCREMENTAL REPLICATION USING SNAPSHOTS

(75) Inventors: Kirill MALKIN, Morris Plains, NJ (US); Yann LIVIS, Bedminster, NJ (US)

(73) Assignee: RELDATA, INC., Parsippany, NJ (US)

(21) Appl. No.: 13/113,870

(22) Filed: May 23, 2011

Related U.S. Application Data
(63) Continuation of application No. 11/470,542, filed on Sep. 6, 2006.
(60) Provisional application No. 60/714,317, filed on Sep. 6, 2005.

(51) Int. Cl. G06F 12/16

(52) U.S. Cl. 711/162; 711/E12.103

(57) ABSTRACT

A first snapshot is taken of a first block storage resource that is initially identical in content to a second block storage resource. A second snapshot of the first block storage resource is taken at a later time. A record is kept of all blocks modified on the first block storage resource. Only those blocks modified between the time of the first and second snapshots are written to the second block storage resource. After all the modified blocks are written to the second block storage resource, a snapshot is taken of the second block storage resource to maintain a consistent snapshot of the second block storage resource in case of communication failure during the next round. The first snapshot is then deleted, the second takes the role of the first, and the next round of replication begins.

### CROSS-REFERENCE TO RELATED APPLICATIONS

This application claims priority under 35 U.S.C. §119 to U.S. Provisional Application No. 60/714,317, filed Sep. 6, 2005, which is herein incorporated by reference in its entirety.

This application contains subject matter which is related to the subject matter of the following applications, each of which is assigned to the same assignee as this application and filed on the same day as this application. Each of the below listed applications is hereby incorporated herein by reference in its entirety:

U.S. patent application Ser. No. ______, by Kirill Malkin, entitled “STORAGE RESOURCE SCAN” (Attorney Docket No. 2660.001A)

U.S. patent application Ser. No. ______, by Malkin et al., entitled “REDUNDANT APPLIANCE CONFIGURATION REPOSITORY IN STANDARD HIERARCHICAL FORMAT” (Attorney Docket No. 2660.002A)

U.S. patent application Ser. No. ______, by Malkin et al., entitled “LIGHTWEIGHT MANAGEMENT AND HIGH AVAILABILITY CONTROLLER” (Attorney Docket No. 2660.003A)

U.S. patent application Ser. No. ______, by Kirill Malkin, entitled “BLOCK SNAPSHOTS OF iSCSI” (Attorney Docket No. 2660.004A)

U.S. patent application Ser. No. ______, by Kirill Malkin, entitled “GENERATING DIGEST FOR BLOCK RANGE VIA iSCSI” (Attorney Docket No. 2660.005A)

U.S. patent application Ser. No. ______, by Kirill Malkin, entitled “PERFORMANCE IMPROVEMENT FOR BLOCK SPAN REPLICATION” (Attorney Docket No. 2660.007A)

U.S. patent application Ser. No. ______, by Dmitry Fomichev, entitled “REUSING TASK OBJECT AND RESOURCES” (Attorney Docket No. 2660.008A)

### BACKGROUND OF THE INVENTION

1. Technical Field

The present invention generally relates to data replication. More particularly, the present invention relates to incremental data replication using snapshots over time.

2. Background Information

Replication of data takes several forms, for example, a backup is the replication of data. However, a backup is time, computing resource and bandwidth intensive.

Thus, a need exists for a more efficient way to replicate data.

### SUMMARY OF THE INVENTION

Briefly, the present invention satisfies the need for a more efficient way of replicating data by providing a method of incremental data replication using the difference between successive snapshots of a storage resource.

In accordance with the above, it is an object of the present invention to provide incremental replication of data that is more efficient than a full backup.

The present invention provides, in a first aspect, a method of incrementally replicating data from an origin block storage resource to a replica block storage resource, wherein all storage blocks of the origin block storage resource initially have identical content in the replica block storage resource. The method comprises taking a first snapshot of the origin block storage resource, and, subsequent to taking the first snapshot, taking a second snapshot of the origin block storage resource. The method further comprises tracking any blocks of the origin block storage resource that are modified between the first snapshot and the second snapshot, and writing the modified blocks to the replica block storage resource.

The present invention provides, in a second aspect, a system for incrementally replicating data. The system comprises an origin block storage resource and a replica block storage resource, wherein all storage blocks of the origin block storage resource initially have identical content in the replica block storage resource. The system further comprises means for taking a first snapshot of the origin block storage resource, and means for, subsequent to taking the first snapshot, taking a second snapshot of the origin block storage resource. The system further comprises means for tracking any blocks of the origin block storage resource that are modified between the first snapshot and the second snapshot, and means for writing the modified blocks to the replica block storage resource.

The present invention provides, in a third aspect, a program product implementing the method of the first aspect.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 is a block diagram of one example of a computing environment implementing the present invention.

FIG. 2 is a flow diagram for one example of a method of incremental replication in accordance with the present invention.

### DETAILED DESCRIPTION OF THE INVENTION

The present invention uses the difference between two snapshots of a block storage resource to replicate the data to another block storage resource. Where two storage resources begin as identical copies, changes to one can be captured via differences in snapshots, and only those differences written to the second storage resource. In this way, incremental replication is achieved, without the need to write the entire contents of the storage resource being replicated, as in the case of a full backup or full copy scenario.

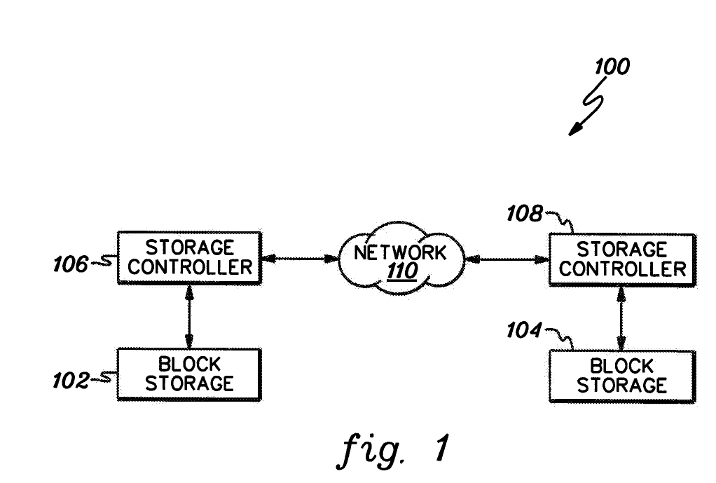

FIG. 1 is a block diagram of one example of a computing environment 100 implementing the present invention. The environment comprises block storage resources 102 and 104, storage controllers 106 and 108 for controlling block storage resources 102 and 104, respectively, and the remainder of a network 110. The network can be any type of network, for example, a local area network or wide area network. The block storage resources are, for example, hard disk drives. The storage controllers are essentially limited purposed computing units running, for example, a UNIX or UNIX derivative operating system, for example, LINUX or a LINUX derivative. Data is transported on the network via, for example, SCSI, iSCSI, Fiber Channel or some combination thereof. In accordance with the present invention, one of the block storage resources, for example, block storage resource 104 is used for incrementally replicating the contents of block storage resource 102.

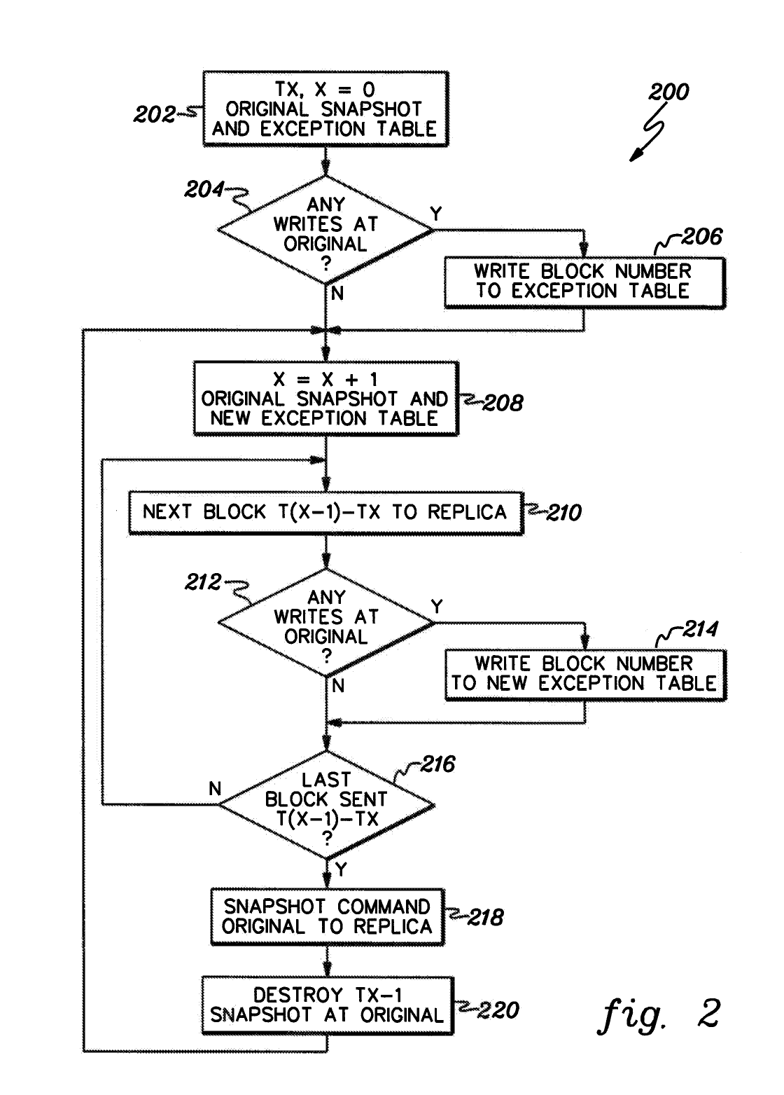

FIG. 2 is a flow diagram 200 for one example of a method of incremental replication in accordance with the present invention. In some manner, the contents of block storage resources 102 and 104 are made exact copies at a time T0. There are various procedures known in the art for accomplishing the same, for example, the contents of block storage resource 102 could simply be copied to block storage resource 104. In any case, the present invention is not concerned with the particular method used to initially “synchronize” the contents of the block storage resources.

As one skilled in the art will know, a block storage resource is a random-access storage resource that has data organized in equal-sized blocks, typically 512 bytes each. Each block can be written or read in its entirety, but one can't read or update less than the entire block. The blocks are numbered from 0 to the maximum number of blocks of the resource. Blocks are referenced by their numbers, and the access time for any block number is fairly similar across the entire resource. Blocks can also be grouped into equal size “chunks” of blocks. Hard disks, as well as compact flash and USB sticks, are examples of block storage resources.

Block storage resources can be physical or virtual. A physical storage resource is a physical device, such as a hard disk or a flash card, that has a fixed number of blocks that is defined during manufacturing or low-level formatting process, usually at the factory. A virtual block storage resource is a simulated device that re-maps its block numbers into the block numbers of a portion of one or more physical block storage resources. As just two examples, a virtual block storage resource with 2,000 blocks can be mapped to: (1) a single physical block storage resource with 10,000 blocks, starting at block 1,000 and ending at block 2,999; or (2) two physical block storage resources, one with 1,000 blocks and another with 5,000 blocks, starting at block 0 and ending at block 999 of the first resource, then starting at block 3,000 and ending at block 3,999 of the second resource. The examples herein assume the use of virtual block storage resources. However, it will be understood that physical block storage resources could instead be used.

Returning to FIG. 2, at a time T0 after the contents of the block storage resources have been made identical, a snapshot of block storage resource 102 is taken (also referred to herein as “the origin block storage resource”) and a first exception table created (Step 202). Preferably, an exception table is created for each new snapshot. Alternatively, one or more snapshots could be indicated in the same exception table, so long as the block storage resource it pertains to is clearly indicated, for example, making that information part of the exception table entry. In one example, a single exception table is used for all block storage resources of the computing environment. Controller 106 originates the snapshot as part of a replication process schedule.

As one skilled in the art will know, snapshots are facilitated by so-called Copy-On-Write (COW) technology, explained more fully below. In addition, a snapshot does not actually make a copy of the data. Rather, pointers (i.e., entries in exception tables) are used in conjunction with copies of blocks that are modified, in order to keep a record of the state of the data at the time of the snapshot. Each exception table entry is essentially a pointer with at least the block or chunk number in origin block storage resource that has been overwritten, and an address for the area of the COW that contains the origin data prior to being overwritten. There could also be additional information in an exception table entry, such as, for example, a timestamp of the creation of the entry. In this way, data can be frozen for various uses without actually affecting the data and without, for example, making an actual copy and sending a large amount of data, saving time and bandwidth. Exception tables actually exist both in memory for consulting, and as part of a COW for persistency, so that a table could be restored after a restart.

For purposes of snapshots, COW occurs when a write operation for a block is directed towards the origin resource that has one or more snapshots. In the present example, there is a single COW per volume, which is shared by snapshots of the same volume. However, it will be understood that a separate COW could be created for each snapshot, rather than using different areas of the same COW. If the block has not been written since the last snapshot, then before the write operation occurs, the content of the block is read and written out to a specially allocated storage area called “COW device.” An exception table entry corresponding to the COW device is created, then the origin resource block is written with the new data. Subsequently, if the origin resource is read, then it would return the data from the block that was just written out; if the snapshot is read, then the exception table is consulted first, and since there is an entry for this block, the content is returned from the COW device. Note that an exception table is created for each snapshot, so in the case of two rolling snapshots, there would be one COW device and two exception tables.

After the initial snapshot is taken, any blocks on the origin block storage resource that are modified are listed in the exception table (Steps 204, 206). Although blocks are being referred to here, it will be understood that for purposes of an exception table, it could really be several blocks treated together as a “chunk.” These are usually of fixed length, typically a power of two across the entire storage resource. This reduces the size of the exception table and the amount of I/O needed. At a subsequent time T1, another snapshot of the origin block storage resource is taken and a second exception table created (Step 208). Upon creation of the second exception table, the first exception table is frozen and cannot be further modified. At this time, the origin block storage resource begins to send (step 210) over the network all blocks modified between the first and second snapshots to block storage resource 104 (also referred to herein as “the replica block storage resource”). The blocks are sent to the replica in the following manner. If a block (or chunk) is in the first exception table, but not the second, then the block contents are fetched from the origin block storage resource (that has new data). If the block is in both exception tables, the block is fetched from the area of the COW device corresponding to the second snapshot, since it has already been overwritten after the second snapshot was taken, so the content that was there between the snapshots is available only in the area of the COW device corresponding to the second snapshot. Note that the replication content will never be fetched from the area of the COW device corresponding to the first snapshot, as it is either not useful if it is the very first snapshot, or it has already been replicated during the previous cycle.

After all storage blocks between the first and second snapshots have been sent from the origin to the replica storage, more accurately, from the origin to storage controller 106, then from controller 106 to controller 108, and finally written to replica storage 104 (Step 216), a snapshot command is sent over iSCSI from controller 106 to controller 108 for the replica storage. Controller 106 sends the snapshot command for the replica storage (Step 218) as the final step of the replication cycle to refresh the replica storage snapshot, thus advancing the replica volume snapshot to the latest consistent state. Specifically, the snapshot from time T0 is deleted (Step 220), and the snapshot from time T1 takes on the role that the T0 snapshot previously played, a “rolling” snapshot scenario. In this way, incremental replication of block storage resource 102 is performed at block storage resource 104.

In another embodiment, more than one replica is made. In that case, all commands and data going to the replica block storage resource described above would also be sent to one or more other replica block storage resources coupled to the network (e.g., at an off-site location for disaster recovery).

One way to accomplish sending a snapshot command between storage controllers is through the use of a vendor-specific command. The present invention also takes advantage of the SCSI Architecture Model-2 Specification (SAM-2), which allows equipment vendors to define their own SCSI commands. See the SAM-2 document at page 57, SAM-2 being incorporated by reference herein in its entirety. See also the SCSI Primary Commands-4 (SPC-4) document (Working Draft Revision 1a, 5 Sep. 2005 at page 27), which is also incorporated by reference herein in its entirety. A standard transport protocol, iSCSI, is used to send a non-standard, i.e., vendor-specific, command. In practice, such a snapshot command simply causes a new snapshot to be taken and the prior one destroyed.

As one skilled in the art will know, SCSI (Small Computer System Interface) is a set of standards to provide interoperability between conforming systems, primarily between storage devices and client hosts. Compliant client hosts are called SCSI initiators and compliant storage servers are called SCSI targets. SCSI devices may communicate with each other using various physical links (aka transport protocols)—parallel and serial interfaces, fiber channel links, TCP/IP, etc.

The main path of SCSI operation is performed as follows. A SCSI initiator sends commands (requests) to a SCSI target for execution and once the request is completed, the target returns an appropriate response to the client initiator. SCSI commands and responses may be accompanied with significant amount of data, which, in turn, requires initiators and targets to maintain some memory buffer space to hold this data during processing. Normally, this memory is not contiguous, but organized as a list of memory buffers, called scatter-gather list.

iSCSI is a standard protocol to facilitate SCSI functionality when operating over TCP/IP transport. iSCSI devices, when communicating with each other, create an initiator-target nexus in the form of iSCSI session. One of the most important implementation goals for iSCSI devices is to achieve adequate or better performance comparing to other available SCSI transport protocols.

The above-described computing environment and/or computing units are only offered as examples. The present invention can be incorporated and used with many types of computing units, computers, processors, nodes, systems, work stations and/or environments without departing from the spirit of the present invention. Additionally, while some of the embodiments described herein are discussed in relation to particular transport protocols, such embodiments are only examples. Other types of computing environments can benefit from the present invention and, thus, are considered a part of the present invention.

The present invention can include at least one program storage device readable by a machine, tangibly embodying at least one program of instructions executable by the machine to perform the capabilities of the present invention. The program storage device can be provided separately, or as a part of a computer system.

The figures depicted herein are just exemplary. There may be many variations to these diagrams or the steps (or operations) described therein without departing from the spirit of the invention. For instance, the steps may be performed in a differing order, or steps may be added, deleted or modified. All of these variations are considered a part of the invention.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A method of incrementally replicating data from an origin block storage resource to a replica block storage resource, wherein all storage blocks of the origin block storage resource initially have identical content in the replica block storage resource, the method comprising:
taking a first snapshot of the origin block storage resource;
subsequent to taking the first snapshot, taking a second snapshot of the origin block storage resource;
tracking any blocks of the origin block storage resource that are modified between the first snapshot and the second snapshot; and
writing the modified blocks to the replica block storage resource.

2. The method of claim 1, wherein the tracking comprises making an entry in an exception table when a modification is made to the origin block storage resource.

3. The method of claim 1, wherein the tracking comprises:
in response to a write operation directed to one or more blocks of the origin block storage resource, copying the content of the one or more blocks to an allocated storage area;
creating an exception table entry corresponding to the copying; and
writing to the one or more blocks of the origin block storage resource in accordance with the write operation, after the copying and creating.

4. The method of claim 3, further comprising in response to a read operation directed to the one or more blocks, returning the content from the allocated storage area if there is an exception table entry for the one or more blocks.

5. The method of claim 3, further comprising repeating the copying, the creating and the writing in response to another write operation directed to the one or more blocks.

6. The method of claim 3, wherein writing the modified blocks to the replica block storage resource comprises, for a given block or group of blocks, writing the given block or group of blocks from the allocated storage area if there is an entry therefor in the most recent exception table, and writing the given block or group of blocks from the origin block storage resource if there is no entry therefor in the most recent exception table.

7. The method of claim 1, further comprising taking a snapshot of the replica block storage resource.

8. The method of claim 7, wherein taking the snapshot of the replica block storage resource is performed after the writing.

9. The method of claim 7, further comprising after the writing, sending a snapshot command to the replica block storage resource.

10. The method of claim 9, wherein the writing comprises a controller for the origin block storage resource sending the modified blocks to a controller for the replica block storage resource for writing to the replica block storage resource, and wherein the snapshot command is sent from the controller for the origin block storage resource to the controller for the replica block storage resource.

11. The method of claim 10, wherein the origin block storage resource and the replica block storage resource are coupled via a network, wherein the writing comprises sending the modified blocks to the replica block storage resource over the network, and wherein the snapshot command is sent over the network via an iSCSI vendor specific command.

12. The method of claim 7, further comprising deleting any prior snapshot of the replica block storage resource.

13. The method of claim 1, wherein the origin block storage resource and the replica block storage resource are coupled via a network, and wherein the writing comprises sending the modified blocks to the replica block storage resource over the network.

14. The method of claim 1, wherein the writing comprises a controller for the origin block storage resource sending the modified blocks to a controller for the replica block storage resource for writing to the replica block storage resource.

15. A system for incrementally replicating data, comprising:
an origin block storage resource;
a replica block storage resource, wherein all storage blocks of the origin block storage resource initially have identical content in the replica block storage resource;
means for taking a first snapshot of the origin block storage resource;
means for, subsequent to taking the first snapshot, taking a second snapshot of the origin block storage resource;
means for tracking any blocks of the origin block storage resource that are modified between the first snapshot and the second snapshot; and
means for writing the modified blocks to the replica block storage resource.

16. The system of claim 15, wherein the means for tracking comprises means for making an entry in an exception table when a modification is made to the origin block storage resource.

17. The system of claim 15, wherein the means for tracking comprises:
means for, in response to a write operation directed to one or more blocks of the origin block storage resource, copying the content of the one or more blocks to an allocated storage area;
means for creating an exception table entry corresponding to the copying; and
means for writing to the one or more blocks of the origin block storage resource in accordance with the write operation, after the copying and creating.

18. The system of claim 17, further comprising, in response to a read operation directed to the one or more blocks, means for returning the content from the allocated storage area if there is an exception table entry for the one or more blocks.

19. The system of claim 17, further comprising means for repeating the copying, the creating and the writing in response to another write operation directed to the one or more blocks.

20. The system of claim 17, wherein the means for writing comprises, for a given block or group of blocks, means for writing the given block or group of blocks from the allocated storage area if there is an entry therefor in the most recent exception table, and means for writing the given block or group of blocks from the origin block storage resource if there is no entry therefor in the most recent exception table.

21. The system of claim 15, further comprising means for taking a snapshot of the replica block storage resource.

22. The system of claim 21, wherein the means for taking comprises means for taking the snapshot of the replica block storage resource after the writing.

23. The system of claim 21, further comprising means for sending a snapshot command to the replica block storage resource after the writing.

24. The system of claim 23, further comprising:
an origin controller for the origin block storage resource;
a replica controller for the replica block storage resource;
wherein the means for writing comprises means for the origin controller to send the modified blocks to the replica controller for writing to the replica block storage resource; and
wherein the means for sending comprises means for sending the snapshot command from the origin controller to the replica controller.

25. The system of claim 24, wherein the origin controller and the replica controller are coupled via a network, and wherein the means for sending comprises means for sending the snapshot command from the origin controller to the replica controller over the network via an iSCSI vendor specific command.

26. The system of claim 21, further comprising means for deleting any prior snapshot of the replica block storage resource.

27. The system of claim 15, wherein the origin block storage resource and the replica block storage resource are coupled via a network, and wherein the means for writing comprises means for sending the modified blocks to the replica block storage resource over the network.

28. The system of claim 27, further comprising:
an origin controller for the origin block storage resource;
a replica controller for the replica block storage resource; and
wherein the means for writing comprises means for the origin controller to send the modified blocks to the replica controller for writing to the replica block storage resource.

29. At least one program storage device readable by a machine tangibly embodying at least one program of instructions executable by the machine to perform a method of incrementally replicating data from an origin block storage resource to a replica block storage resource, wherein all storage blocks of the origin block storage resource initially have identical content in the replica block storage resource, the method comprising:
taking a first snapshot of the origin block storage resource;
subsequent to taking the first snapshot, taking a second snapshot of the origin block storage resource;
tracking any blocks of the origin block storage resource that are modified between the first snapshot and the second snapshot; and
writing the modified blocks to the replica block storage resource.

30. The at least one program storage device of claim 29, wherein the tracking comprises making an entry in an exception table when a modification is made to the origin block storage resource.

31. The at least one program storage device of claim 29, wherein the tracking comprises:
in response to a write operation directed to one or more blocks of the origin block storage resource, copying the content of the one or more blocks to an allocated storage area;
creating an exception table entry corresponding to the copying; and
writing to the one or more blocks of the origin block storage resource in accordance with the write operation, after the copying and creating.

32. The at least one program storage device of claim 31, further comprising in response to a read operation directed to the one or more blocks, returning the content from the allocated storage area if there is an exception table entry for the one or more blocks.

33. The at least one program storage device of claim 31, further comprising repeating the copying, the creating and the writing in response to another write operation directed to the one or more blocks.

34. The at least one program storage device of claim 31, wherein writing the modified blocks to the replica block storage resource comprises, for a given block or group of blocks, writing the given block or group of blocks from the allocated storage area if there is an entry therefor in the most recent exception table, and writing the given block or group of blocks from the origin block storage resource if there is no entry therefor in the most recent exception table.

35. The at least one program storage device of claim 29, further comprising, taking a snapshot of the replica block storage resource.

36. The at least one program storage device of claim 35, wherein taking the snapshot of the replica block storage resource is performed after the writing.

37. The at least one program storage device of claim 35, further comprising after the writing, sending a snapshot command to the replica block storage resource.

38. The at least one program storage device of claim 37, wherein the writing comprises a controller for the origin block storage resource sending the modified blocks to a controller for the replica block storage resource for writing to the replica block storage resource, and wherein the snapshot command is sent from the controller for the origin block storage resource to the controller for the replica block storage resource.

39. The at least one program storage device of claim 38, wherein the origin block storage resource and the replica block storage resource are coupled via a network, wherein the writing comprises sending the modified blocks to the replica block storage resource over the network, and wherein the snapshot command is sent over the network via an iSCSI vendor specific command.

40. The at least one program storage device of claim 35, further comprising deleting any prior snapshot of the replica block storage resource.

41. The at least one program storage device of claim 29, wherein the origin block storage resource and the replica block storage resource are coupled via a network, wherein the writing comprises sending the modified blocks to the replica block storage resource over the network.

42. The at least one program storage device of claim 29, wherein the writing comprises a controller for the origin block storage resource sending the modified blocks to a controller for the replica block storage resource for writing to the replica block storage resource.
